(19) United States
(12) Patent Application Publication
(10) Pub. No.: US 2015/0019237 A1
(43) Pub. Date: Jan. 15, 2015

(54) HOLISTIC PATIENT ADVISORY SYSTEM, METHOD, AND SOFTWARE

(71) Applicant: Covidien LP, Mansfield, MA (US)

(72) Inventors: Peter Doyle, Vista, CA (US); Gardner James Kimm, Carlsbad, CA (US); Mehdi M. Jafari, Laguna Hills, CA (US); Warren Sanborn, Escondido, CA (US); Sidney A. Jacobi, San Marcos, CA (US); Robert Hartman, San Marcos, CA (US)

(21) Appl. No.: 13/942,017

(22) Filed: Jul. 15, 2013

(51) Int. Cl. G06F 19/00

(52) U.S. Cl. CPC G06F 19/3418
USPC 705/2

(57) ABSTRACT

A method for computer assisted holistic patient monitoring includes receiving patient parameters from at least one medical device monitoring a patient, receiving historical patient data from a database, receiving clinician-generated data from a remote device, generating advisory feedback based on the received patient parameters, the received historical data, and the received clinician-generated data, and outputting the advisory feedback for review by a clinician. The method may further include the step of receiving a clinician response to the advisory feedback and storing the clinician response in the database. Additionally, the advisory feedback may be delivered to a second remote device operated by a supervising clinician. In embodiments, the advisory feedback may include a differential analysis and modeling of a patient state, a request for additional examination, a status report on disease progress or disease improvements, and/or a status report indicating treatment incompatibilities and patient deteriorating conditions.

### TECHNICAL FIELD

The present disclosure relates generally to a computer assisted holistic patient monitoring system, method, and software using multiple factors in generating advisory feedback.

### BACKGROUND

Medical devices are commonly used for monitoring and applying therapy to patients. One example of a medical device is a medical ventilator that mechanically helps patients breathe by replacing some or all of the muscular effort required to inflate and deflate the lungs. When medical devices are used to monitor and/or apply therapy to patients, it is crucial that a clinician is supervising the progress of the patient. The clinicians are required to continuously change treatment and monitoring plans of the patient throughout the course of the patient's treatment.

### SUMMARY

Aspects of the present disclosure are directed to a system, method, and computer readable recording medium capable of generating advisory feedback based on multiple factors including patient parameters, patient historical data, user generated data, and other data stored in a database. Certain aspects of the present disclosure describe a platform for the hosting of algorithms that embody clinical experience and research findings, and for the application of these algorithms to produce advisory feedback based on several input parameters.

In accordance with aspects of the present disclosure a method for generating advisory feedback is disclosed including receiving patient parameters from a medical device which is monitoring a patient, receiving historical patient data from a database, receiving clinician-generated data from a remote device operated by the clinician, generating advisory feedback based on the received patient parameters, the received historical data, and the received clinician-generated data, and outputting the advisory feedback for review by a clinician. The method may further include the step of receiving a clinician response to the advisory feedback and storing the clinician response in the database. The generated advisory feedback may be delivered to the remote device operated by the clinician. Additionally, the generated advisory feedback may be delivered to a second remote device operated by a supervising clinician. In embodiments, the advisory feedback may include a differential analysis and modeling of a patient state, a request for additional examination, a status report on disease progress or disease improvements, and/or a status report indicating treatment incompatibilities and patient deteriorating conditions.

The present disclosure provides new and unique advantages to monitoring systems over the prior monitoring systems. By considering multiple factors received and stored in a database, the system may holistically generate advisory feedback for a clinician monitoring a patient which is specific to the patient being monitored and which can consider data that is not readily available to a clinician. In particular, the generated advisory feedback may be used to assist the clinician in monitoring the patient. Intelligent algorithms may be used to generate and deliver the advisory feedback using resident baseline knowledge-based models for normal subjects as well as subjects with different demographics and etiologies. Examples of the advisory feedback may include, without limitation, a differential analysis and modeling of a patient state, a request for additional examination, a status report on disease progress or disease improvements, and/or a status report indicating treatment incompatibilities and patient deteriorating conditions.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic illustration of one example of a system for computer assisted holistic patient monitoring, according to certain embodiments of the present disclosure;

FIG. 2 is a schematic illustration of one example of a remote device of the system of FIG. 1, according to certain embodiments of the present disclosure;

FIG. 3 is a schematic illustration of an example data collection server of the system of FIG. 1, according to certain embodiments of the present disclosure;

FIG. 4 is a flow chart depicting a method for generating advisory feedback and monitoring a patient using the system of FIG. 1, according an embodiment of the present disclosure;

FIG. 5 is a an exemplary flow chart of the method of FIG. 4, according to an example embodiment of the present disclosure; and

FIG. 6 is one example of a graphical user interface of a remote device, according to certain embodiments of the present disclosure.

### DETAILED DESCRIPTION

The present disclosure incorporates the use of a database in a system to holistically assist a clinician in monitoring and treating a patient by generating advisory feedback. The database includes multiple relational database capabilities; a comprehensive medical knowledge base; received patient parameters generated and gathered by medical devices monitoring the patient and other patients; and various online patient profiles provided by clinicians and specialists. The term clinician as used herein is meant to include any individual or group of individuals that monitor patients or are otherwise responsible for overseeing or treating patients.

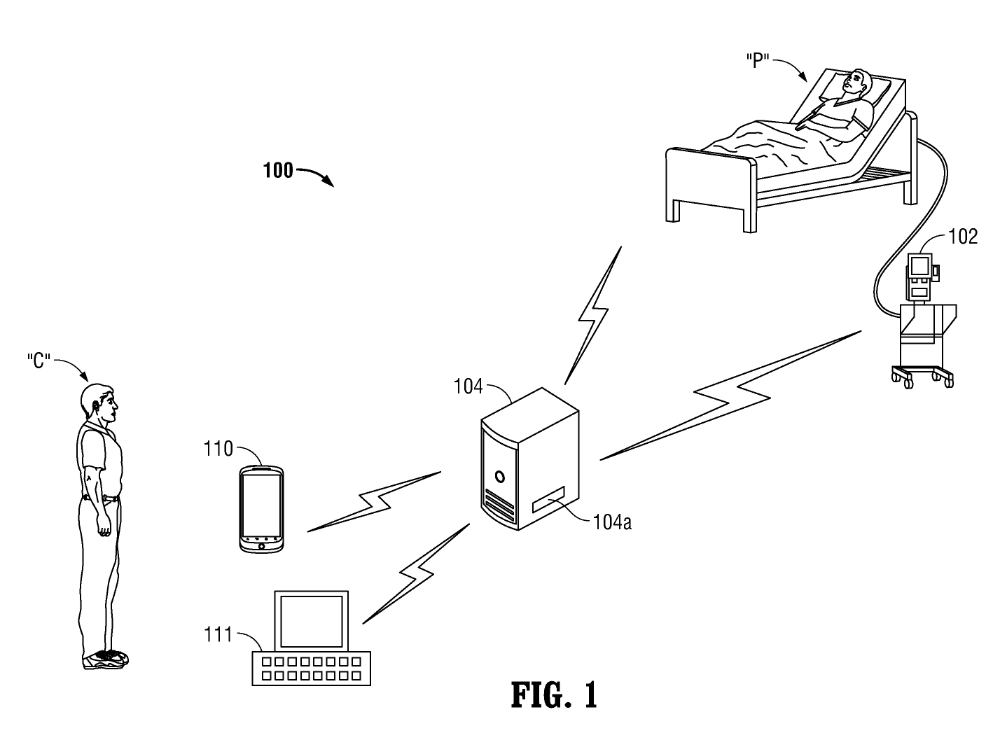

FIG. 1 illustrates one example of a system, generally designated as system 100, for computer assisted holistic patient monitoring, according to certain embodiments of the present disclosure. System 100 includes one or more data collection servers 104, communicatively coupled to one or more medical devices 102, which monitor and/or apply therapy to a patient “P” and to one or more remote devices 110 and further to computing devices 111. Although this particular implementation of system 100 is illustrated and primarily described, the present disclosure contemplates any suitable implementation of system 100 according to particular needs of the institution or facility.

As noted above, system 100 includes one or more medical devices 102 to monitor a patient or apply a therapy to a patient. In certain embodiments, the medical devices 102 generate patient data from monitored patient physiological vital signs. Generated patient data may include any patient: identifiers, parameters, medical history, clinician notes, alarm thresholds, alarm events, device settings, measurements of values indicating physiological conditions such as oxygen saturation levels, respiratory rates, heart rates, other vital signs, and any other data input to or output from medical devices 102. Medical devices 102 may store the patient data locally, or transmit it to the data collection server 104 for storage in database 104a, or both. As described above, medical devices 102 may be any devices that are used for monitoring, tracking or treating patients. For example, medical devices 102 may include: a ventilator connected to a patient to deliver respiration therapy; a pulse oximeter that monitors the oxygen saturation of a patient's blood; a device for tracking a patient within a hospital, with or without monitoring a physiological condition; digital thermometers that measure the temperature of the patient; as well as other medical devices known to those of skill in the art.

Medical devices 102 may display the patient data on a display of the medical device 102 or another suitable display, such as and without limitation a central computing unit or any of remote devices 110. Medical devices 102 are communicatively coupled to data collection server 104 such that signals and data may be transmitted between medical devices 102 and data collection server 104. The patient data from the medical device 102 may be: constantly streamed to the data collection server 104, periodically posted to the data collection server 104, or the data collection server 104 may periodically poll the medical device 102 for the patient data. Further, other protocols may be employed based on alarming conditions, such that the data collection server 104 receives important data in a timely manner, regardless of any set period for collection of the patient data. Medical devices 102 may be communicatively coupled to data collection server 104 via a network such as a LAN, WAN, or WiLAN employing one or more of well-known network communication protocols, or may be hardwired to data collection server 104.

Data collection server 104 includes one or more electronic computing devices operable to receive, transmit, process, and store data associated with system 100, in particular, the patient parameters received from medical devices 102 and other patient data in database 104a. Data collection server 104 uses any suitable operating system, as would be understood by those of skill in the art. Although a single data collection server 104 is illustrated, the present disclosure contemplates system 100 including any suitable number of data collection servers 104. Moreover, although referred to as a data collection server, the present disclosure contemplates data collection server 104 comprising any suitable type of processing or computing device or devices.

Data collection server 104 includes a database 104a which stores all data received from the remote devices 110, computing device 111, and medical devices 102. In particular, database 104a stores data corresponding to patient parameters generated by different medical devices 102, which are monitoring different patients and stores the received patient parameters as historical patient data corresponding to the particular patients being monitored in database 104a for further processing. Data collection server 104 is also configured to receive clinician-generated data and store the clinician-generated data in database 104a for further processing. The clinician-generated data may be received upon data collection server 104 requesting further information from a clinician.

In embodiments, data collection server 104 is configured to process all of the received and stored information and generate advisory feedback for review by a clinician. In an embodiment, data collection server 104 hosts instructions that generate advisory feedback using several parameters including: biometric values; patient history; data generated by clinicians; data included in a medical knowledge base; etc. The advisory feedback generated by data collection server 104 may include: differential analysis and modeling of patient state; requests for examination by additional specialists or different clinicians; requests for new or additional tests to be performed on the patient; overall patient status updates regarding disease progress or improvements; alarming conditions where patient parameters exceed safe or threshold values; and notifications of incompatible pharmaceutical combinations or treatment therapies, etc. In embodiments, the advisory feedback generated is delivered to either or both of the remote devices 110 operated by clinicians or a computing device 111, as described in further detail below.

As noted above, data collection server 104 is communicatively coupled to either or both of one or more remote devices 110 and a computing device 111. Although illustrated and described as separate components, in particular embodiments, computing device 111 and data collection server 104 are a single component. In embodiments, remote devices 110 and computing device 111 are communicatively coupled to data collection server 104 via a network such as a LAN, WAN, or WiLAN employing one or more of well-known network communication protocols, or may be hardwired to data collection server 104.

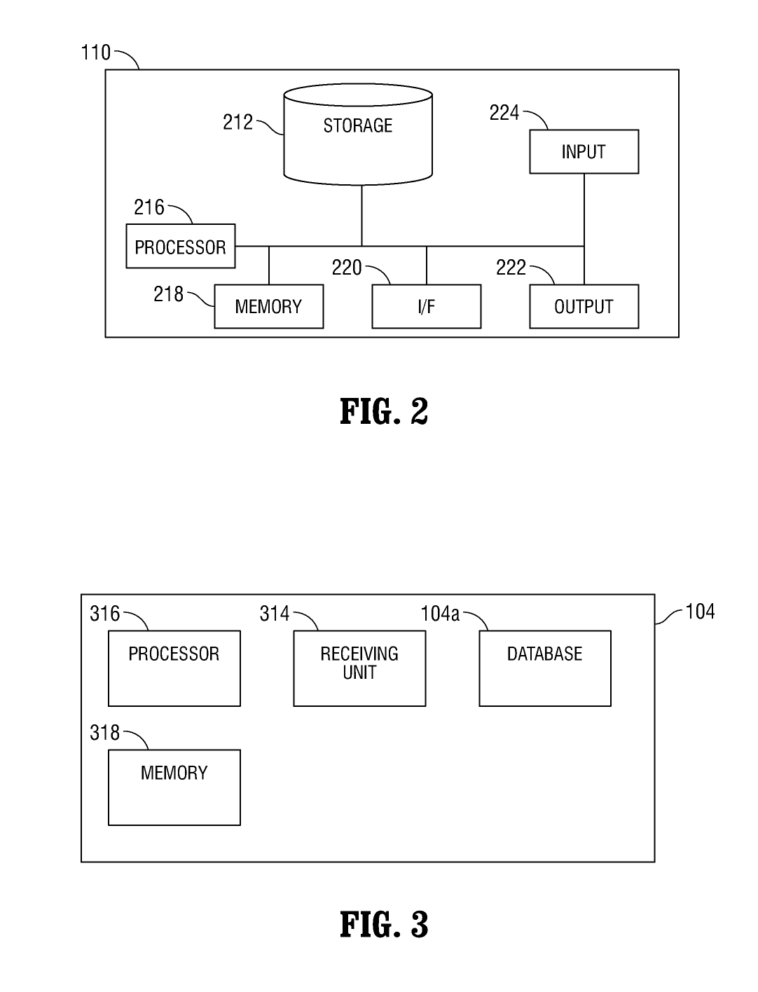

FIG. 2 illustrates a detailed view of an exemplary remote device 110 of system 100, according to certain embodiments of the present disclosure. Remote devices 110 may be any device that provides output to, and can receive input from, a user, such as a clinician “C”. In certain embodiments, output at remote devices 110 includes vibrations, display views including pop-up messages, sound, or any combination desired. Each remote device 110 includes input components (such as a keypad, touch screen, mouse, or other device that can accept input), output devices, mass storage media, or other suitable components for receiving, processing, storing, and communicating data.

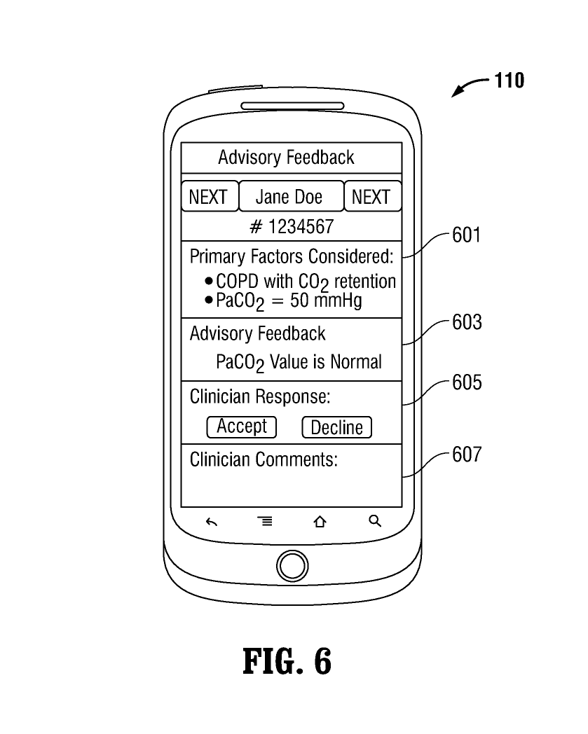

According to one embodiment, remote devices 110 display one or more web pages in the form of GUI's (FIG. 6), which may be hosted by data collection server 104, and display advisory feedback generated by the data collection server 104. The remote device 110 can also receive data from any of the components of system 100, and transmit data to any of the components of system 100.

Remote device 110 includes a processor 216, a memory 218, a communication interface (I/F) 220, an output device 222, and an input device 224, which are described in further detail below. Although this particular implementation of remote device 110 is illustrated and primarily described, the present disclosure contemplates any suitable implementation of remote device 110 according to particular needs.

Continuing with reference to FIG. 2, storage device 212 is similar to database 104a and may include any suitable device operable for storing data and instructions, which may be executable by processor 216. Storage device 212 includes, for example, Random Access Memory (RAM) or Read Only Memory (ROM), Electrically Erasable Programmable Read-only Memory (EEPROM), a magnetic disk, flash memory, optical disk, or other suitable data storage device, including any of those listed below with reference to memory 218.

Memory 218 and/or storage device 212 may include software or instructions that when executed by the processor 216 cause the processor 216 to perform any of the methods described herein. Examples of the instructions may include a “thick client”, i.e., a networked computer with most resources installed locally, rather than distributed over a network, such as a native application that runs on the remote device 110, receives data from the data collection server 104 and conducts its own processing and data manipulation. Alternatively, the instructions may be a “thin client” interface, i.e., a networked computer that depends heavily on a server to fulfill its computational roles, enabling display of data received from data collection server 104, and all processing and data manipulation occurs at the data collection server 104 and is made available via a browser such as, for example, the brand name browsers: Mozilla® (Firefox®), Internet Explorer®, Google Chrome®, Safari® or any other current or future browsers. Memory 218 includes any computer memory (for example, RAM or ROM), mass storage media (for example, a hard disk), removable storage media (for example, a Compact Disk (CD), a Digital Video Disk (DVD), or USB Flash Drive), database and/or network storage (for example, a server). Memory 218 may comprise any other computer-readable tangible medium, or a combination of any of the preceding.

Processor 216 includes any suitable device operable to execute instructions and manipulate data to perform operations. Processor 216 may include, for example, any type of central processing unit (CPU).

Interface (I/F) 220 includes any suitable device operable to receive input, send output, perform suitable processing of the input or output or both, communicate to other devices, such as other remote devices 110, medical devices 102, and/or data collection server 104, or any combination of the preceding. I/F 220 may include appropriate hardware (for example, a modem, network interface card, etc.) and software, including protocol conversion and data processing capabilities, to communicate through a LAN, WAN, or other communication system that allows remote device 110 to communicate with other devices.

Output device 222 includes any suitable device operable for displaying information to a user, for example in the form of a GUI (FIG. 6). Output device 222 may include, for example, a touch screen, a video display, a printer, a plotter, or other suitable output device. Input device 224 includes any suitable device operable to input, select, and/or manipulate various data and information. Input device 224 may include, for example, a touch screen, a keyboard, mouse, graphics tablet, joystick, light pen, microphone, scanner, or other suitable input device.

Modifications, additions, or omissions may be made to remote device 110 without departing from the scope of the present disclosure. The components of remote device 110 may be integrated or separated. Moreover, the operations of remote device 110 may be performed by more, fewer, or other components. Additionally, in some embodiments, remote devices 110 are configured to transmit data to the data collection server 104. The data collection server 104 includes a processing unit or processor and memory storing instructions that cause the processor to carry out any or all of the functions and/or methods described with respect to the processes carried out by the mobile devices 110.

In particular, and turning now to FIG. 3, which illustrates a detailed view of an example data collection server 104 of system 100, according to certain embodiments of the present disclosure. Data collection server 104 includes a receiving unit 314, processor 316, memory 318, and database 104a. The processor 316 and memory 318 of data collection server 104 are similar to the processor 216 and memory 218 of remote device 110 (FIG. 2) and therefore will not be further described.

Receiving unit 314 may include any suitable device for receiving data from the mobile devices 110 and/or medical devices 102 for storage in database 104a and/or processing by the processor 316. In particular, receiving unit 316 receives the patient parameters generated by medical devices 102 monitoring patients for storage in the database 104a to carry out any of the methods and processes described below. The data received from remote devices 110 and medical devices 102 may be pulled by the receiving unit 314 or may be pushed by the remote devices 110 and medical devices 102.

As noted above, database 104a stores all of the patient data, which may include for example, real-time patient parameters generated by medical devices 102 that are monitoring patients, patient history and historical data, images of patients, etc. In embodiments, the patient data stored in database 104a includes patient profiles, which include data corresponding to the patient's age, gender, disease status, medical history, medication list with dosage frequency, etc. Database 104a also stores clinician-generated data, which is received by data collection server 104. Database 104a may include multiple databases, which are communicatively linked to each other. For example, in one embodiment, database 104a includes a cloud storage area, which accesses multiple databases on multiple servers. Database 104a also includes a comprehensive knowledge base, which includes general medical knowledge. The comprehensive medical knowledge base may include differential diagnosis tools, physiologic models of normal and disease subsystems, current and/or accepted medical practices, treatment options, clinical research, disease information, diagnosis information, alternate modes of therapy or treatment, etc.

In embodiments, data collection server 104 processes one or more algorithms to automatically generate the advisory feedback based on the parameters processed. For example, the data collection server 104 continuously receives input parameters (such as biometric values collected by medical devices, clinician generated notes, etc.) and processes the parameters according to the algorithms. The result of the processing using the algorithms is the generated advisory feedback. In this regard, data collection server 104 may serve as a central location for storing and processing several algorithms to generate the advisory feedback.

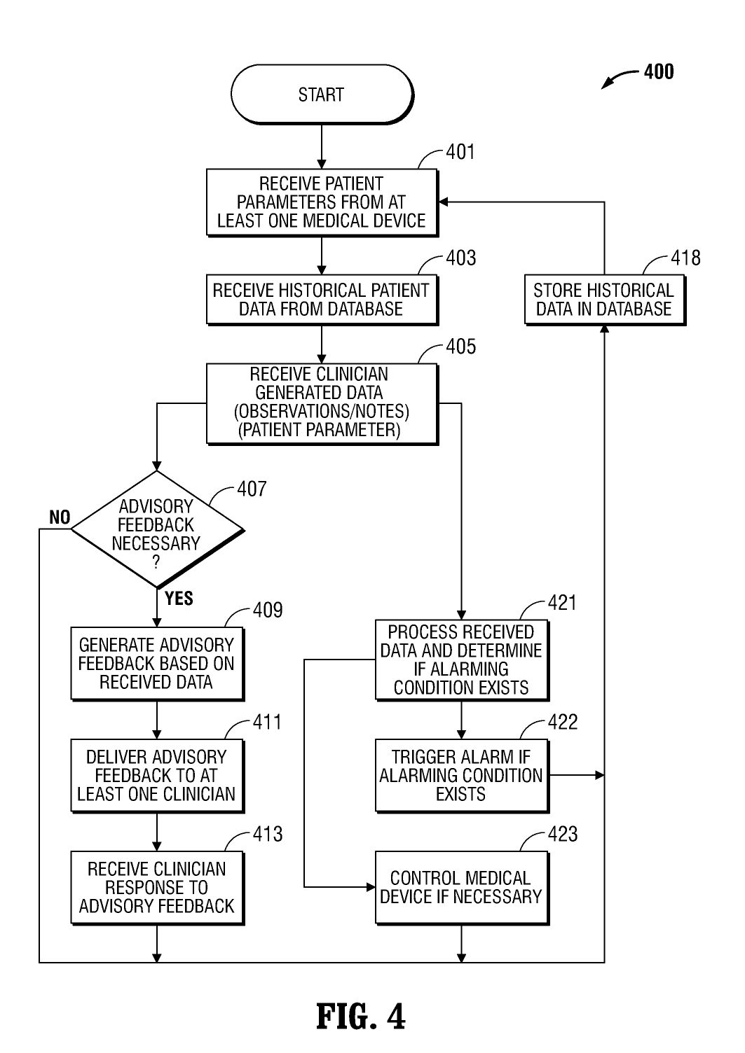

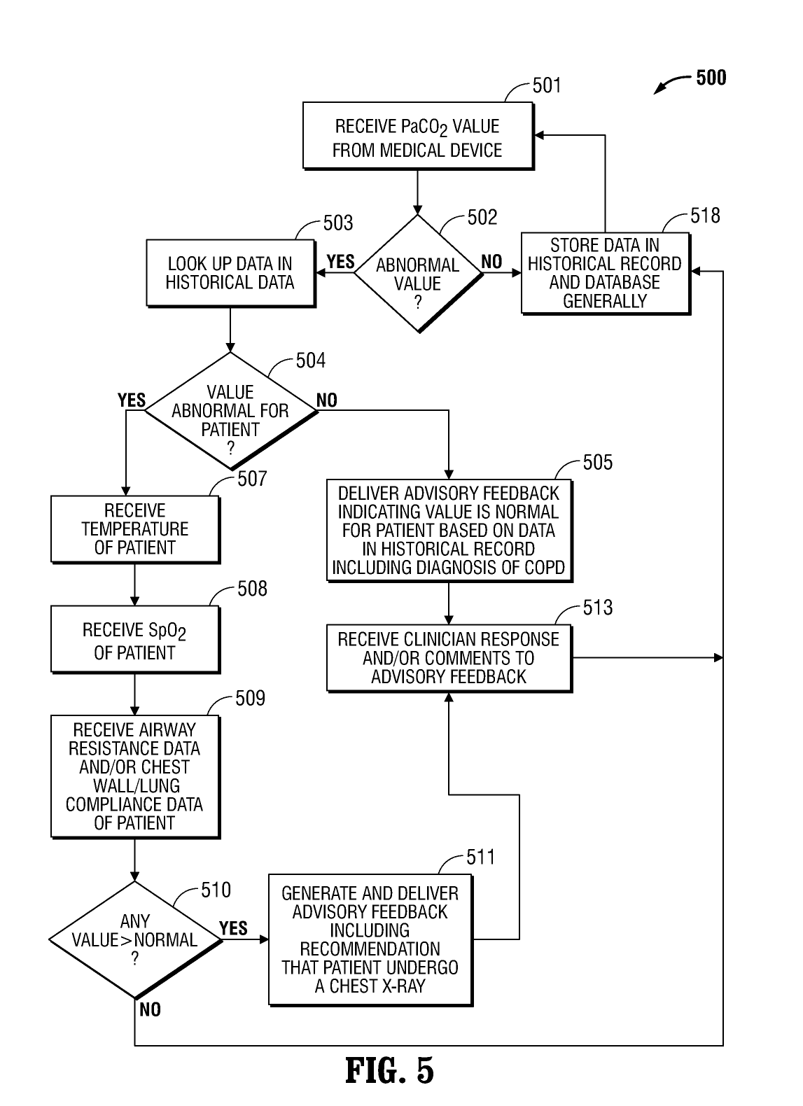

Turning now to FIGS. 4-5, methods for generating advisory feedback for a clinician are illustrated and will now be described. The methods described herein are processes stored in the form of instructions in the memory 218, 318 of remote devices 110 and/or data collection server 104, which when executed by the processor 216, 316, cause the processor 216, 318 to carry out the steps of the methods. It is envisioned that although the methods described herein are illustrated and described as including particular steps and are described as in a particular order, the methods may include some or all of the steps and may be arranged in any order not specifically described.

With particular reference to FIG. 4, a method for generating advisory feedback is illustrated and described as method 400. Method 400 begins at step 401 where data collection server 104 receives patient parameters from the patient monitoring medical devices 102. As described above, in some embodiments, data collection server 104 receives the patient parameter data from medical devices 102 in real time. In step 403, data collection server 104 receives historical patient data corresponding to the patient being monitored from the database 104a. The data received in step 403 may include medical history data of the patient, diagnosis information, patient conditions, etc. In step 405, data collection server 104 receives clinician-generated data. In embodiments, the clinician-generated data includes observations of the patient made by the clinician that the clinician believes can be relevant in assisting the data collection server 104 to generate advisory feedback or any other information that the clinician wants to store in database 104a. In embodiments, the clinician-generated data also includes patient profiles provided by specialists. Subsequent to any or all of steps 401, 403, and 405, method 400 proceeds to either or both of steps 407 and 421, as described in further detail below.

In step 407, data collection server 104 determines if advisory feedback is required. The process by which the determination is made in step 407 is described in further detail with reference to FIG. 5. If it is determined that advisory feedback is not required (i.e., NO in step 407), then method 400 proceeds to step 418 where the data, including the determination and all of the data received in step 401, 403, and 405, are stored in database 104a as historical data. After updating the database 104a in step 418, method 400 reverts back to step 401 to receive new patient parameters.

Alternatively, if it is determined that advisory feedback is required (i.e., YES in step 407), then method 400 proceeds to step 409 where advisory feedback is generated based on the data received in steps 401, 403, and 405. In step 411, the generated advisory feedback is delivered to at least one clinician. In an embodiment, in step 411 data collection server 104 delivers the advisory feedback to a remote device 110 operated by a clinician. In some embodiments, the delivery destination of the advisory feedback is dependant upon the type of generated advisory feedback. For example, advisory feedback that is pertinent to a managing clinician may be delivered to a remote device 110 operated by the managing clinician and all of the remote devices 110 operated by clinicians working with the managing clinician. In some embodiments, the advisory feedback is printed by a clinician-operated printer. In yet another embodiment, the advisory feedback is delivered to a central monitoring station and/or any other computing device 111.

In step 413, data collection server 104 receives a clinician response to the advisory feedback delivered in step 411. In this regard, a clinician can review the advisory feedback and either accept, decline, and/or insert comments on, the advisory feedback. Once the data collection server 104 receives the clinician response, method 400 reverts to step 418 where the clinician response is stored in the database 104a. In this regard, the clinician response may be used by data collection server 104 in future processing when determining if advisory feedback is necessary (step 407) and/or in generating the content of the advisory feedback (step 409).

As noted above, subsequent to any or all of steps 401, 403, and 405, method 400 also proceeds to step 421. In step 421, data collection server 104 processes all of the data received (the patient parameters, historical patient data, and clinician-generated data) and determines if an alarming condition exists. The process by which this determination is made is described in further detail with reference to the exemplary embodiment described in FIG. 5. In step 422, an alarm is triggered if it has been determined in step 421 that an alarming condition exists.

Additionally, or alternatively, in step 423, one or more of the medical devices 102 that are monitoring or applying a therapy to the patient can be controlled if necessary. For example, if the medical device 102 is a respiratory ventilation machine, data collection server 104 may cause the respiratory ventilation machine to prompt a change in the ventilation therapy if the received patient parameters are approaching dangerous levels or exceeding predetermined threshold levels (below minimum or above maximum levels).

Subsequent to completing either or both of steps 422 and 423, method 400 proceeds to step 418 where all of the data is stored in the database 104a as historical patient data. With all of the data stored as historical patient data in the database 104a, system 100 may use the newly acquired historical data in future implementations of any of the methods described herein.

Turning now to FIG. 5, an exemplary method for generating advisory feedback and monitoring a patient is illustrated and described as method 500. Method 500 begins at step 501 where data collection server 104 receives a partial pressure value of CO₂ in a patient's arterial blood (Pa CO₂) which is monitored by a medical device 102. Upon receiving the value from the medical device 102, in step 502, data collection server 104 determines if the PaCO₂ value received in step 501 is an abnormal value. A normal value is considered a value, which falls within an accepted range, and an abnormal value is a value that falls outside of the accepted range (below a minimum or above a maximum value). The accepted ranges can be configured by a clinician or can be ranges which are determined by the data collection server 104 based on data included in the comprehensive medical knowledge base which is stored in the database 104a. If the value is determined to be normal (i.e., NO in step 502), then method 500 proceeds to step 518 where the data is stored as historical record data in the database 104a, and method 500 reverts back to step 501 to receive a new value from the medical device 102.

Alternatively, if the value received in step 501 is an abnormal value (i.e., YES in step 502), then in step 503, data collection server 104 looks up the patient's historical record in the database 104a. By searching the historical record of the patient in step 503, data collection server 104 can holistically determine if the value received in step 501, although falling outside a normal range for a normal or different patient, is a value, which is considered normal for the particular patient being monitored. For example, the historical record in database 104a may include information regarding a particular diagnosis, or other relevant data, for the specific patient being monitored. Such data could indicate that the value, although normally high and considered abnormal for a different patient, is not high for this particular patient and is therefore considered normal in this specific case, as will be described in further detail below.

In one non-limiting example, the value received in step 501 is 50 mmHg. In step 502, data collection server 104 would determine that a partial pressure of CO₂ in a patient's arterial blood of 50 mmHg is not considered a normal value, because the medical knowledge stored in the database 104a indicates that a normal value is 40 mmHg. Thus, in this example, method 500 proceeds to step 503, where the data collection server 104 proceeds to pull up the patient's historical record from the database 104a. In this case, the historical record includes a previous diagnosis of chronic obstructive pulmonary disease (COPD) with CO₂ retention (as compared to COPD without CO₂ retention). Using the patient's historical data, and in particular the data indicating that the patient has been diagnosed with COPD with CO₂ retention, in step 504, the data collection server 104 determines that the value of 50 mmHg is considered a normal value for this patient.

Specifically, in step 503, the data collection server 104 searches for a new normal value when determining if the received value is high. The new normal value is determined by searching the medical knowledge base in the database 104a while considering the historical patient data (here, the diagnosis of COPD with CO₂ retention). In this example, as would be indicated in the medical knowledge base, a normal value of partial pressure of CO₂ in arterial blood for a patient diagnosed with COPD with CO₂ retention is 50 mmHg. Thus, although data collection server 104 determines in step 502 that the value of 50 mmHg is abnormal, in step 504 data collection server 104 determines that the value of 50 mmHg is normal after considering the data indicating that the patient has been diagnosed with COPD with CO₂ retention. Thus, in the particular example described above, method 500 would proceed to step 505 because in step 504 it was determined that the value for this patient is not abnormal (i.e., NO in step 504).

In step 505, data collection server 104 delivers the advisory feedback indicating that the value is normal for the particular patient based on data included in the historical record for the patient, which includes a diagnosis of COPD with CO₂ retention. In embodiments, the advisory feedback is delivered to a remote device 110 operated by a clinician in the form of a GUI illustrated in FIG. 6. In step 513, data collection server 104 receives a clinician response to the advisory feedback generated with optional clinician comments. In step 513, the response and comments are then stored in the database 104a in either or both of the historical patient data and for future generation of advisory feedback.

Alternatively, if it is determined that the value is abnormal even for the particular patient while considering the patient historical record data (i.e., YES in step 504), then method 500 proceeds to any or all of steps 507, 508, and 509. In step 507, data collection server 104 receives the temperature of the patient from a medical device 102 that is monitoring the temperature of the patient. In step 508, data collection server 104 receives the arterial oxygen level (SpO₂ level) of the patient from a medical device 102 monitoring the SpO₂ level of the patient. In step 509, data collection server 104 receives airway resistance data and/or chest wall/lung compliance data of the patient.

In step 510, data collection server 104 determines if any of the values received in steps 507, 508, or 509 are greater than normal, below normal, or otherwise exceed a preconfigured threshold level. If all of the values are normal (i.e., NO in step 510), then method 500 reverts to step 518 where all of the received data is stored in the database 104a. Alternatively, in step 510 if any of the values are greater than normal (i.e., YES in step 510), then in step 511 data collection server 104 generates and delivers advisory feedback. In one non-limiting example, the advisory feedback generated would include a recommendation that the patient undergo a chest x-ray. Subsequent to delivering the advisory feedback in step 511, method 500 proceeds to step 513.

As described above, in step 513 data collection server 104 receives a clinician response to the advisory feedback. The clinician response may include comments on the advisory feedback including reasons why the clinician agrees or disagrees with the advisory feedback generated. In step 518, the clinician response and comments are stored in the database 104a so that they may be used in generating advisory feedback during the implementation of method 500.

A second non-limiting example of an implementation of methods 400 and 500 will now be described. In this example, when data collection server 104 receives SpO₂ levels greater than 88%, it would suggest that the inspired oxygen therapy should be lowered. When the data collection server 104 searches the patient's historical record in the database 104a, the historical patient data includes an indication that the particular patient is a premature neonatal patient. In this example, the medical knowledge base includes an indication that large swings in SpO₂ levels may predispose premature neonatal patients to eye damage (retinopathy of prematurity “ROP”). Thus, the data collection server 104 generates an advisory feedback including a warning of any trends in fluctuation and advises the clinician to tighter swings in SpO₂ level control of the patient.

Turning now to FIG. 6, a display of a remote device 110 is shown with a GUI according to one embodiment of the present disclosure. Remote device 110 is shown with cells 601, 603, 605, 607. Although these cells are illustrated and described, it is envisioned that the GUI may include all or some of the cells, and may also include additional cells not particularly illustrated.

Cell 601 includes a list of primary factors considered by the data collection server 104 when the data collection server 104 generates the advisory feedback. Displaying the factors included in cell 601 may assist a clinician in determining the reliability of the advisory feedback. Cell 603 includes a display of the generated advisory feedback. Cell 605 includes an area where a clinician may input whether the clinician accepts or rejects the advisory feedback generated by the data collection server 104. Cell 607 includes an area where a clinician may input notes or comments. The comments may be related to the advisory feedback and/or the patient.

Certain embodiments of the present disclosure comprise logic for generating advisory feedback, and may be embodied in at least one tangible, computer-readable medium. For example, portions of the logic may be embodied in one or more of medical device 102, data collection server 104, and remote device 110 of system 100 in any manner.

Although the present disclosure describes certain embodiments, various alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for computer assisted holistic patient monitoring, comprising the steps of:
receiving patient parameters from at least one medical device monitoring a patient;
receiving historical patient data from a database;
receiving clinician-generated data from a remote device;
generating advisory feedback based on the received patient parameters, the received historical data, and the received clinician-generated data; and
outputting the advisory feedback for review by a clinician.

2. The method according to claim 1, further comprising the step of receiving a clinician response to the advisory feedback and storing the clinician response in the database.

3. The method according to claim 1, wherein the step of outputting the advisory feedback includes delivering the advisory feedback to the remote device and further comprising the step of delivering the advisory feedback to a second remote device, wherein the second remote device is operated by a supervising clinician.

4. The method according to claim 1, wherein the advisory feedback includes a differential analysis and modeling of a patient state.

5. The method according to claim 1, wherein the advisory feedback includes a request for additional examination.

6. The method according to claim 1, wherein the advisory feedback includes a status report on disease progress or disease improvements.

7. The method according to claim 1, wherein the advisory feedback includes a status report indicating treatment incompatibilities and patient deteriorating conditions.

8. A system for computer assisted holistic patient monitoring, comprising:
a processor; and
a memory storing instructions executable by the processor, wherein the instructions when executed by the processor cause the system to:
receive patient parameters from at least one medical device monitoring a patient;
receive historical patient data from a database;
receive clinician-generated data from a remote device;
generate advisory feedback based on the received patient parameters, the received historical data, and the received clinician-generated data; and
output the advisory feedback for review by a clinician.

9. The system according to claim 8, wherein the instructions when executed by the processor further cause the system to receive a clinician response to the advisory feedback and store the clinician response in the database.

10. The system according to claim 8, wherein the output advisory feedback is delivered to the remote device and wherein the instructions when executed by the processor further cause the system to deliver the advisory feedback to a second remote device, wherein the second remote device is operated by a supervising clinician.

11. The system according to claim 8, wherein the advisory feedback includes a differential analysis and modeling of a patient state.

12. The system according to claim 8, wherein the advisory feedback includes a request for additional examination.

13. The system according to claim 8, wherein the advisory feedback includes a status report on disease progress or disease improvements.

14. The system according to claim 8, wherein the advisory feedback includes a status report indicating treatment incompatibilities and patient deteriorating conditions.

15. A non-transitory computer-readable storage medium storing a program which, when executed by a computer, causes the computer to perform a method for computer assisted holistic patient monitoring, comprising the steps of:
receiving patient parameters from at least one medical device monitoring a patient;
receiving historical patient data from a database;
receiving clinician-generated data from a remote device;
generating advisory feedback based on the received patient parameters, the received historical data, and the received clinician-generated data; and
outputting the advisory feedback for review by a clinician.

16. The non-transitory computer-readable storage medium according to claim 15, further comprising receiving a clinician response to the advisory feedback and storing the clinician response in the database.

17. The non-transitory computer-readable storage medium according to claim 15, wherein the step of outputting the advisory feedback includes delivering the advisory feedback to the remote device and further comprising delivering the advisory feedback to a second remote device, wherein the second remote device is operated by a supervising clinician.

18. The non-transitory computer-readable storage medium according to claim 15, wherein the advisory feedback includes a differential analysis and modeling of a patient state.

19. The non-transitory computer-readable storage medium according to claim 15, wherein the advisory feedback includes a request for additional examination.

20. The non-transitory computer-readable storage medium according to claim 15, wherein the advisory feedback includes a status report on disease progress or disease improvements.
